(19) United States
(12) Patent Application Publication
(10) Pub. No.: US 2016/0264023 A1
(43) Pub. Date: Sep. 15, 2016

(54) MEANS FOR SLIDABLY CONNECTING A PASSENGER SEAT WITH A VEHICLE STRUCTURE

(71) Applicant: Franz Kiel GmbH, Noerdlingen (DE)

(72) Inventor: Juergen Mill, Ellwangen (DE)

(21) Appl. No.: 14/657,858

(22) Filed: Mar. 13, 2015

(51) Int. Cl. B60N 2/16; B60N 2/005

(52) U.S. Cl. CPC B60N 2/1685; B60N 2/005

(57) ABSTRACT

A device (2) for displaceably connecting a passenger seat (1) to a vehicle structure (3) has devices (8) for fitting the passenger seat (1) and a device (5) for engaging in a guide (4) which is connected to the vehicle structure (3). The device (5) for engaging in the guide (4) has a securing pin (5a) which can be moved out of engagement with a recess (6) in the guide (4) by means of a lifting device (9). The lifting device (9) has a resilient device (10) which pretensions the securing pin (5a) against the guide (4) in the state thereof moved out of engagement with the recess (6) in the guide (4).

The invention relates to a device for displaceably connecting a passenger seat to a vehicle structure, having devices for fitting the passenger seat and having a device for engaging in a guide which is connected to the vehicle structure.

Displaceable passenger seats in buses are known from the general prior art. For example, it may be necessary to displace a plurality of seats in the longitudinal direction of the vehicle in order to provide larger free space in which a wheelchair user can be accommodated.

The known solutions are, however, mostly relatively complex to operate, whereby the provision of the free space in the vehicle requires a very large amount of time.

An object of the present invention is therefore to provide, for displaceably connecting a passenger seat to a vehicle structure, a device which is simple and reliable to operate.

This object is achieved according to the invention by the features mentioned in claim 1.

The securing pin according to the invention which is provided for engagement in the recess of the guide and which can be moved out of engagement with the recess by means of the lifting device on the one hand ensures secure fixing of the device according to the invention and consequently also of the passenger seat which is fitted thereto with respect to the vehicle structure and can on the other hand be very simply removed from the recess by means of the lifting device, whereby the connection between the device and the vehicle structure can be cancelled and the entire passenger seat can be displaced.

In this instance, the securing pin is pretensioned according to the invention against the guide in the state thereof in which it is located outside the recess so that the securing pin engages in the next recess in the guide when the passenger seat is displaced along the guide which is connected to the vehicle structure. For the person displacing the passenger seat, this has the advantage that only the securing pin is brought out of engagement with the recess by means of the lifting device and subsequently the passenger seat has to be displaced along the guide, whereas the device according to the invention itself ensures engagement in the next recess when the passenger seat is displaced along the guide and in this manner produces a new connection between the passenger seat and the vehicle structure at another location within the vehicle.

If, in a very advantageous development of the invention, the guide has a plurality of recesses which are arranged with specific spacings from each other, on the one hand, a passenger seat can be fitted in several different positions along the vehicle structure and, on the other hand, it is possible to displace a plurality of passenger seats along the vehicle structure and to secure them at different positions.

Another advantageous embodiment of the invention may involve there being connected to the lifting device rollers which, during the lifting movement of the securing pin by means of the lifting device, are lowered onto the guide. Using these rollers, which are lowered onto the guide when the securing pin is moved out of engagement, simpler displacement of the device according to the invention along the guide is possible since the friction between the securing pin which is pressed onto the guide with the resilient device and the guide is considerably reduced.

Simple control of the device according to the invention is achieved when the lifting device has a control plate.

When the securing pin is at least indirectly connected to the control plate by means of tension springs which belong to the resilient device and control levers which are connected to the tension springs and the control plate, simple control of the resilient device which presses the securing pin onto the guide is achieved.

In order to move the rollers with respect to the guide, the rollers can be connected to the control plate by means of the control levers.

In another advantageous embodiment of the invention, there may be provision for the lifting device to have an actuation rod which acts on the securing pin. Simple and effective actuation of the device is thereby possible.

In order to prevent unintentional actuation of the device, there may further be provision for the actuation rod to be able to be blocked by means of a locking element.

When the locking element can be moved by means of an unlocking rod assembly into the position thereof which releases the movement of the actuation rod, simple release of the movement of the actuation rod is possible.

Blocking of the entire device can be achieved by the control plate being able to be blocked by means of a locking element.

If there is further provision for locking arms which can be pressed onto the guide to be operationally connected to the control plate, particularly good locking of the passenger seat to the vehicle structure can be achieved.

Other advantageous embodiments and developments of the invention will be appreciated from the remaining dependent claims. An embodiment of the invention is illustrated schematically below with reference to the drawings.

In the drawings:

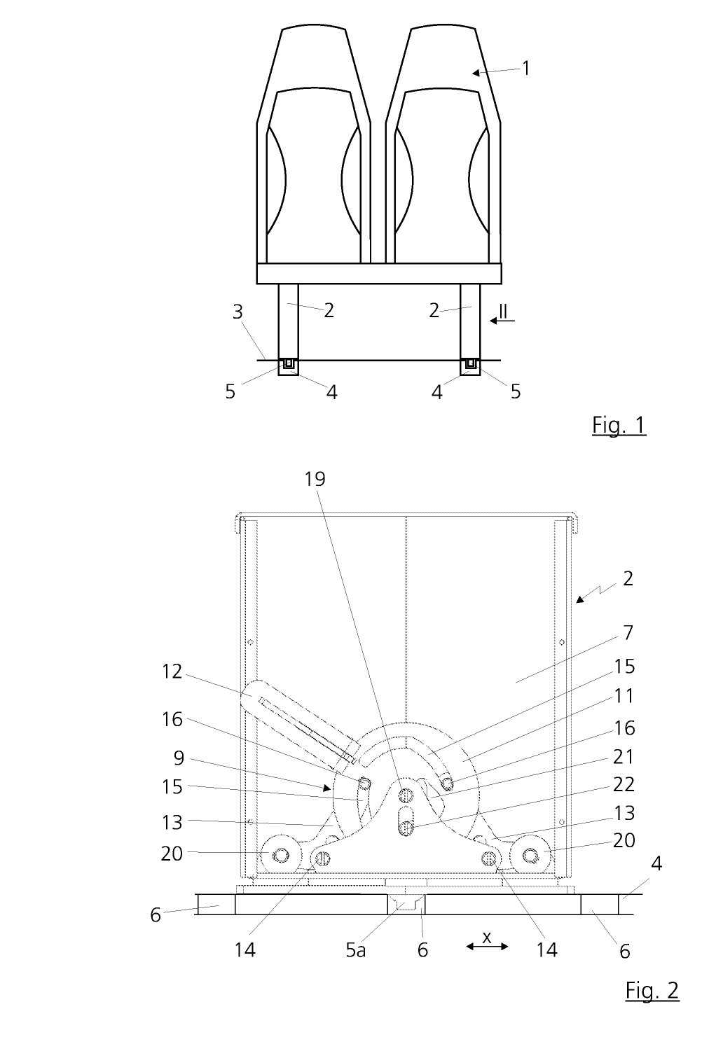

FIG. 1 is a very schematic view of a passenger seat which is displaceably connected to a vehicle structure by means of a device according to the invention;

FIG. 2 is a side view of a first embodiment of the device according to the invention according to the arrow II from FIG. 1 in a first state;

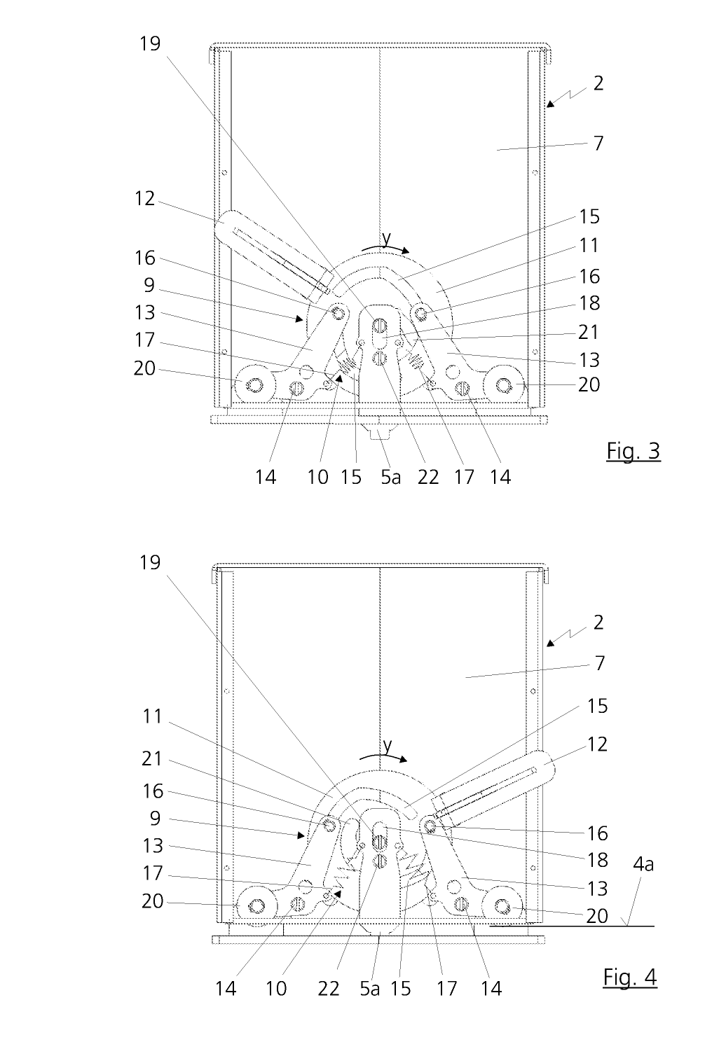

FIG. 3 is another illustration of the device from FIG. 2;

FIG. 4 shows the device from FIG. 3 in another state;

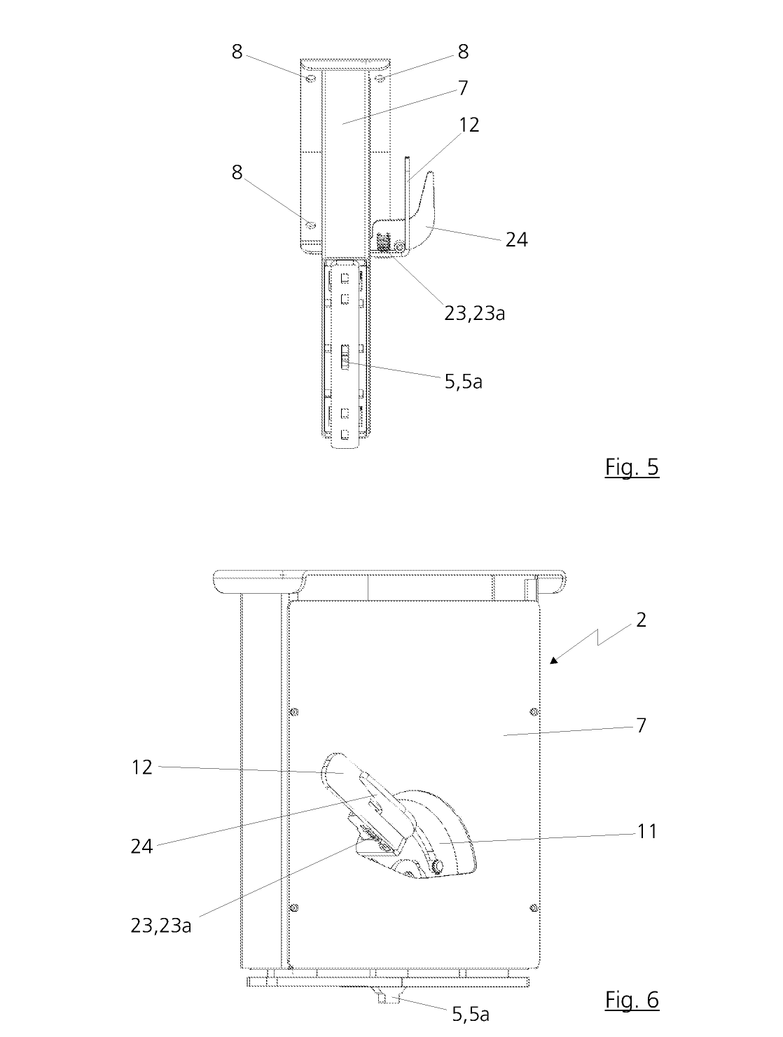

FIG. 5 is a perspective view of the device in the state of FIG. 2;

FIG. 6 is another perspective view of the device in the state of FIG. 2;

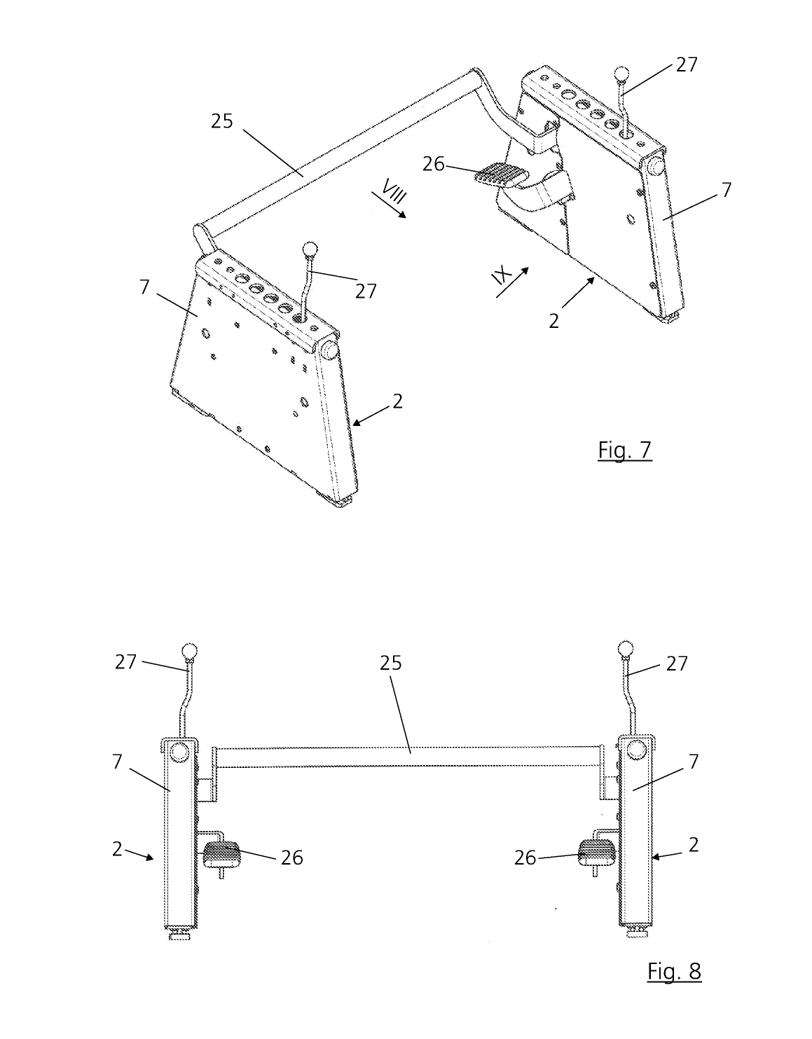

FIG. 7 is a perspective view of a second embodiment of the device according to the invention;

FIG. 8 is a view of the device according to the arrow VIII from FIG. 7;

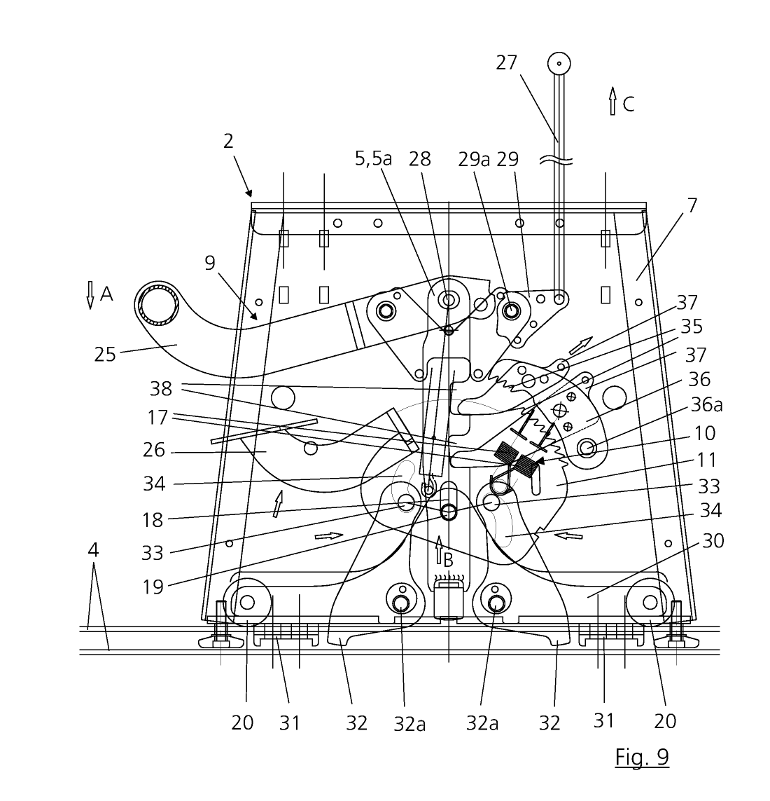

FIG. 9 is a side view of the device according to the arrow IX from FIG. 7 in a first state; and

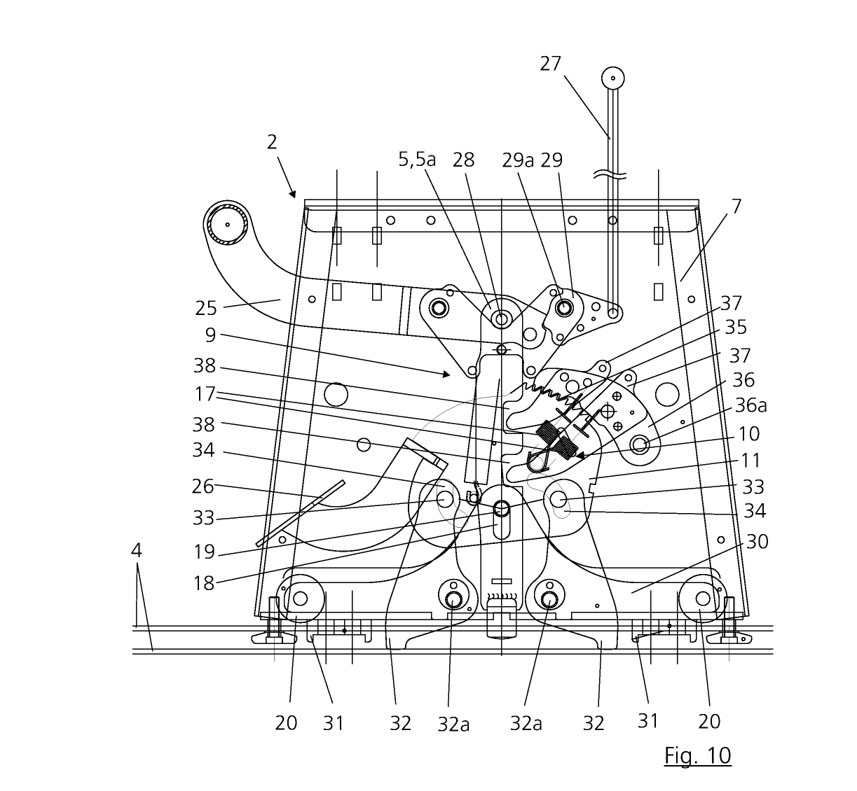

FIG. 10 shows the device from FIG. 9 in another state.

FIG. 1 shows a passenger seat 1 which is displaceably fitted by means of two devices 2 to a vehicle structure 3 of a vehicle which is not illustrated, for example, a bus. Although in principle it would be possible to connect the passenger seat 1 to the vehicle structure 3 using only one device 2, two devices 2 are generally used for reasons of stability. The two devices 2 are constructed in a substantially identical or mirror-inverted manner, for which reason the following description thereof applies to an equal extent to both devices 2.

The displacement of the passenger seat 1 with respect to the vehicle structure 3 serves to provide a free space within the vehicle, for example, in order to be able to accommodate a wheelchair user. When the seat faces of the passenger seat 1 which are not described in greater detail can be folded upward, passenger seats 1 which are arranged one behind the other can be pushed very close together so that, as a result of the displacement of a few passenger seats 1, a relatively large free space is already produced.

The vehicle structure 3 which is in this instance a floor of the vehicle has two guides 4 which are connected thereto and to which the devices 2 are connected. To this end, the devices 2 have respective devices 5 for engagement in the respective guide 4.

FIG. 2 shows a first embodiment of one of the two devices 2 in greater detail. In this instance, it can be seen that the device 5 for engagement in the guide 4 of the vehicle structure 3 has a securing element or a securing pin 5a or in this instance is constructed as such a member. In order to receive the securing pin 5a, the guide 4 has a plurality of recesses 6 which are arranged with specific spacings from each other and in which the securing pin 5a can engage, as illustrated by way of example in FIG. 2. The spacings which the recesses 6 have from each other each represent a specific path which can be travelled depending on the application when the passenger seat 1 is displaced along the guides 4. The displacement direction of the device 2 and consequently the passenger seat 1 is indicated in FIG. 2 with the double-headed arrow “x”.

The device 2 has a console 7 which is arranged between the passenger seat 1 and the vehicle structure 3 and which has devices 8 which are illustrated in FIG. 5 and which are constructed as holes for fitting the passenger seat 1. The console 7 forms a frame in which the individual components of the device 2 are arranged or supported.

Furthermore, the device 2 has a lifting device 9 by means of which the securing pin 5a can be lifted and consequently moved out of engagement with the recess 6 in the guide 4. The lifting device 9 in turn has a resilient device 10 which can be seen in the detailed illustration of FIG. 3 and which pretensions the securing pin 5a against the guide 4 in the state thereof brought out of engagement with the recess 6 in the guide 4. That is to say, in the state in which the securing pin 5a has been lifted from the recess 6, the resilient device 10 presses the securing pin 5a in the direction of the guide 4.

In FIG. 3, it can further be seen that the lifting device 9 has a control plate 11 which can be rotated by means of an actuation lever 12 which also belongs to the lifting device 9 from the state illustrated in FIG. 3 in accordance with the arrow “y” into the state illustrated in FIG. 4. The lifting device 9 further has two control levers 13 which are spaced apart from each other and which are arranged in the present case symmetrically relative to the securing pin 5a and which are each fitted in a rotatable manner about a rotation location 14 to the console 7. Furthermore, the two control levers 13 are supported in respective eccentric grooves 15 of the control plate 11. This support is produced by means of a pin 16 which is fitted to the respective control lever 13 and which engages in the eccentric groove 15 so that the control lever 13 is retained therein. Furthermore, the two control levers 13 are connected to the securing pin 5a by means of tension springs 17 which belong to the resilient device 10. To this end, the tension springs 17 are suspended, on the one hand, in the respective control lever 13 and, on the other hand, in the securing pin 5a. The pin 16 is thus connected to the control plate 11 by means of the two tension springs 17 and the two control levers 13. Furthermore, the securing pin 5a has an elongate hole 18 in which there engages a pin 19 which is arranged on the control plate 11 and which ensures guiding of the securing pin 5a.

At the side opposite the support of the control levers 13 by means of the pins 16 in the eccentric grooves 15, there are fitted to the control levers 13 respective rollers 20 which, as described below, are lowered onto the guide 4 during the lifting movement of the securing pin 5a using the lifting device 9.

As can be seen from a comparison of FIG. 3 with FIG. 4, during the movement of the actuation lever 12 in accordance with the arrow “y”, the control plate 11 is rotated accordingly. The control levers 13 are thereby moved as a result of their support in the eccentric grooves 15 which rotate with the movement of the control plate 11 and rotate about the rotation location 14. This ensures that the rollers 20 are moved downward onto the guide 4. Since the guide 4, as explained above, is constructed as a rail which is U-shaped in cross-section, the rollers 20 are lowered onto an upper portion 4a of the U-shaped rail, which portion is only indicated in FIG. 4, whereby the significant portion of the force acting on the guide 4 by the passenger seat 1 via the device 2 is applied when the passenger seat 1 is displaced by the rollers 20. The securing pin 5a is in contrast pressed onto the guide 4 only by the force of the two tension springs 17. In this manner, damage to the guide 4 is prevented. Of course, in this context, the securing pin 5a may be provided at the side facing the guide 4 with a coating or the like which ensures that the securing pin 5a does not damage the guide.

At the same time, when the control plate 11 is moved in accordance with the arrow “y” by means of the actuation lever 12, the securing pin 5a is raised from the position thereof illustrated in FIG. 3 into the position illustrated in FIG. 4. To this end, the securing plate 11 has in addition to the two eccentric grooves 15 an additional control or eccentric groove 21 in which there engages another pin 22 which is securely connected to the securing pin 5a. As a result of the rotation of the control plate 11, the pin 22 which engages in the eccentric groove 21 is restrictedly guided and consequently pushes the securing pin 5a upward.

During this upward movement of the securing pin 5a, the two tension springs 17 are tensioned, whereby they ensure that the securing pin 5a, as already mentioned above, is pretensioned or pressed onto the guide 4. In this state, the passenger seat 1 can be displaced with the two devices 2 along the guide 4 with respect to the vehicle structure 3. The securing pin 5a then engages in the next recess 6 and the passenger seat 1 is locked in a position remote from the original position thereof.

After the securing pin 5a has been moved out of engagement with the recess 6 and the passenger seat 1 has been slightly displaced with respect to the vehicle structure 3, the actuation lever 12 can be released in order to enable the securing pin 5a to be pressed into the next recess 6 by means of the force of the resilient device 10. When the securing pin 5a is introduced into the recess 6, the tension springs 17 are relaxed and the rollers 20 return to their position of FIG. 3 as a result of the rotation of the control levers 13.

In FIG. 5, it can be seen that the actuation lever 12 has a securing device 23 which in turn has a spring 23a and which can be moved by means of a release device 24 which is constructed in the form of a lever into a position in which the actuation lever 12 can be used to rotate the control plate 11. That is to say, before the actuation lever 12 is actuated, it must be released by means of the release device 24.

In FIG. 6, the device 2 is illustrated in another perspective view and it is possible to see in particular the securing device 23 and the release device 24 of the actuation lever 12.

FIGS. 7 to 10 show a second embodiment of the device 2 for displaceably connecting the passenger seat 1 to the vehicle structure 3. The device 2 according to FIGS. 7 to 10 has a structure which is similar in principle to the device 2 described with reference to FIGS. 2 to 6, for which reason a description of details thereof which have previously already been explained has been partially dispensed with.

The lifting device 9 has in this embodiment an actuation rod 25 which replaces the actuation lever 12 according to FIGS. 2 to 6 and which mutually connects the two devices 2 which are spaced apart from each other by the width of the passenger seat 1 which is constructed in the present case as a double seat. Simultaneous actuation of the two devices 2 of the passenger seat 1 is thereby achieved. Furthermore, there is associated with each of the two devices 2 a locking pedal 26 whose function is explained in greater detail below. Furthermore, for each of the two devices 2, there is provided an unlocking rod assembly 27 which serves to unlock the actuation rod 26 and whose function is also described in greater detail below with reference to FIGS. 9 and 10.

In the front view of FIG. 8, the two devices 2, the actuation rod 25 which is arranged between them, the two actuation pedals 26 and the two unlocking rod assemblies 27 can also be seen clearly.

FIGS. 9 and 10 show the device 2 as a side view in two different states or positions. In this instance, FIG. 9 shows the unlocked or released state and FIG. 10 the locked or secured state of the device 2.

It can be seen in this instance that the securing pin 5a is connected to the actuation rod 25 at a rotation location 28. When the actuation rod 25 is actuated in the direction designated “A”, the securing pin 5a is thereby pulled upward in the direction designated “B” and consequently moved into the unlocked position thereof. In a similar manner to the embodiment of FIGS. 2 to 6, the securing pin 5a is also supported in this instance via the pin 19 in the elongate hole 18 in order to guide this movement of the securing pin 5a in the direction of the arrow “B”.

In order to enable the described actuation of the actuation rod 25 in the arrow direction “A”, a locking element 29 which retains the actuation rod 25 in the upper position thereof according to FIG. 10 is first moved by means of the unlocking rod assembly 27 from the position according to FIG. 10 into the position according to FIG. 9. To this end, the unlocking rod assembly 27 is moved upward in the arrow direction designated “C”, which can be carried out, for example, by means of a coupling of the unlocking rod assembly 27 with a seat face (not illustrated) or a seat cushion of the passenger seat 1. The locking element 29 is thereby moved into the unlocking position of FIG. 9 and the actuation rod 25 can be unlocked only if the seat face is located in a state folded upward. The seat cushion or the seat face may be arranged in such a manner that it retains the locking element 29 in the locking position. When the seat cushion is pivoted, an unlocking of the locking element 29 can then be provided via the unlocking rod assembly 27 which is connected to the seat cushion. The locking element 29 in this instance is rotatably fitted to the console 7 by means of a rotation location 29a.

The locking element 29 is constructed in such a manner that, when the actuation rod 25 moves upward, the locking element 29 automatically locks the actuation rod 25 in the upper position. It is thereby possible to actuate the actuation rod 25 only by unlocking the locking element 29 via the unlocking rod assembly 27.

In the unlocked state of the securing pin 5a, the console 7, as described in the embodiment according to FIGS. 2 to 6, can be moved via the rollers 20 on the guide 4. As in the embodiment of FIGS. 2 to 6, there is also provided in this instance the resilient device 10 which presses the securing pin 5a counter to the arrow “B” in the direction of the guide 4 so that the securing pin 5a engages therein when the next recess 6 in the guide 4 is reached.

The two rollers 20 are supported on a common guiding element 30 which extends at both sides of the securing pin 5a and which, when the securing pin 5a is raised, is moved in the direction of the guide 4 so that the rollers 20 are positioned on the guide 4 and a movement of the rollers 20 on the guide 4 is possible. Furthermore, there are connected to the guiding element 30 in the present case two sliding blocks 31 which are located in the released position of FIG. 9 with spacing from the guide 4 and consequently enable the movement of the console 7 along the guide 4. In contrast, the sliding blocks 31 are located in the position of FIG. 10 in contact with the lower side of the guide 4 and, together with the respective locking arms 32, thereby lock the console 7 to the guide 4.

In the present case, when the console 7 is tensioned via the sliding blocks 31 and the locking arms 32, a specific spacing of the console 7 from the guide 4 is produced. Furthermore, the rollers 20 have spacing from the guide 4 in the locked position. In contrast, the console 7 moves downward during the movement from the locked position according to FIG. 10 into the unlocked position according to FIG. 9.

The locking arms 32 act counter to the direction of the sliding blocks 31 so that a tensioning of the console 7 on the guide 4 is achieved. In order to move the locking arms 32, they are rotatably supported at respective rotation locations 32a. Furthermore, the locking arms 32 are movably supported by means of pins 33 in respective eccentric grooves 34 which are located in the control plate 11 which is also provided in the embodiment of FIGS. 7 to 10. As can be seen from a comparison of FIGS. 9 and 10, a rotation of the control plate 11 leads to the pins 33 being rotated as a result of the guiding thereof in the eccentric grooves 34 and consequently the locking arms 32 ultimately pressing on the guide 4.

In order to achieve this rotation of the control plate 11 and the locking of the console 7 with respect to the guide 4, the locking pedal 26 is moved from the position according to FIG. 9 into the position according to FIG. 10. This actuation of the respective locking pedal 26 further results in a locking element 36 which is in engagement with the control plate 11 by means of a respective tooth arrangement 35 reaching, from the position illustrated in FIG. 9, the position illustrated in FIG. 10 in which the two tooth arrangements 35 on the control plate 11 and the locking element 36 are in engagement with each other in order to prevent a movement of the control plate 11. In order to enable the rotation of the locking element 36, it is supported at a rotation location 36a.

The unlocking of the locking element 36 is ensured by two unlocking elements 37 which are coupled thereto and which engage, on the one hand, on the locking element 36 and, on the other hand, in respective recesses 38 of the securing pin 5a so that, when the securing pin 5a is moved upward in accordance with the arrow “B”, they are pressed upward in order to move the locking element 36 into the position of FIG. 9. During this movement, the tension springs 17 of the resilient device 10 which are also present in this embodiment are further tensioned. As a result of the tensioning of the resilient device 10, as already mentioned, in a similar manner to the embodiment of FIGS. 2 to 6, the pretensioning of the securing pin 5a in the direction of the guide 4 is brought about.

Furthermore, in this manner, the locking pedal 26 is moved by means of an actuation of the actuation rod 25 from the lower position thereof which locks the console 7 with respect to the guide 4 into the upper position thereof which is illustrated in FIG. 9 and which enables the movement of the console 7 with respect to the guide 4 and consequently the movement of the passenger seat 1. The locking pedal 26 is in this instance moved into the upper position thereof by means of the force of the resilient device 10.

1. A device for displaceably connecting a passenger seat to a vehicle structure having devices for fitting the passenger seat comprising:
an engaging device for engaging in a guide connected to the vehicle structure
wherein the engaging device for engaging in the guide comprises a securing pin which can be moved out of engagement with a recess in the guide by means of a lifting device the lifting device having a resilient device which pretensions the securing pin against the guide in the state thereof moved out of engagement with the recess in the guide.

2. The device of claim 1
wherein the guide has a plurality of recesses which are arranged with specific spacings from each other.

3. (canceled)

4. The device according to claim 1
wherein the lifting device has a control plate.

5. The device according to claim 4
wherein the securing pin is at least indirectly connected to the control plate by means of tension springs which belong to the resilient device and control levers which are connected to the tension springs and the control plate.

6. The device according to claim 3,
wherein the rollers are connected to the control plate by means of the control levers

7. The device according to claim 6,
wherein the control plate has respective eccentric grooves in which the control levers are supported at the ends thereof opposite the rollers.

8. The device according to claim 4,
wherein the control plate can be rotated by means of an actuation lever.

9. The device according to claim 8
wherein the actuation lever has a securing device which can be moved by means of a release device into a position which releases the movement of the control plate by means of the actuation lever.

10. The device of claim 1
wherein the lifting device has an actuation rod which acts on the securing pin.

11. The device of claim 10,
wherein the actuation rod can be blocked by means of a locking element.

12. The device of claim 11
wherein the locking element can be moved by means of an unlocking rod assembly into the position thereof which releases the movement of the actuation rod.

13. The device of claim 4
wherein the control plate can be blocked by means of a locking element.

14. The device of claim 4
further comprising locking arms which can be pressed onto the guide are the locking arms operationally connected to the control plate.

15. The device of claim 4
wherein the guide is constructed as a rail which is U-shaped in cross-section.
